(19) United States
(12) Patent Application Publication
(10) Pub. No.: US 2007/0067325 A1
(43) Pub. Date: Mar. 22, 2007

(54) Methods and apparatus to load and run software programs in data collection devices

(75) Inventors: Jorge Weitzner, Raanana (IL); Daniel Fainsod, Reut (IL)

Correspondence Address: XSapio, Ltd.;att. Jorge Weitzner, 5 Hagdud Haivri, Raanana, 43559, IL

(73) Assignee: XSAPIO, LTD., Raanana (IL)

(21) Appl. No.: 11/307,594

(22) Filed: Feb. 14, 2006

Related U.S. Application Data
(60) Provisional application No. 60/593,784, filed on Feb. 14, 2005.

(51) Int. Cl. G06F 7/00

(52) U.S. Cl. 707/101

(57) ABSTRACT

Method and apparatus for creating, storing, loading and running programs used by devices incorporating a microprocessor and integrating or connected to RFID readers, such as data collection stations, data collection terminals, access gates, cellular phones and electrical or electronic devices, which may incorporate sensors for determining temperature, location, weight, or any other physical or chemical characteristic of the area o material surrounding the sensor.

### FIELD OF THE INVENTION

This invention relates to automatic identification systems, methods and program products. More particularly, the invention relates to an RFID system: methods, systems and program products.

### BACKGROUND OF INVENTION

In computing, an operating system (OS) is the system software responsible for the direct control and management of hardware and basic system operations, as well as running application software. In general, the operating system is the first layer of software loaded into computer memory when it starts up. As the first software layer, all other software that gets loaded after it depends on this software to provide them with various common core services. These common core services include, but are not limited to: disk access, memory management, task scheduling, device interfacing and user interfacing. Since these basic common services are assumed to be provided by the OS, there is no need to re-implement those same functions over and over again in every other piece of software that you may use. The portion of code that performs these core services is called the “kernel” of the operating system. Operating system kernels had been evolved from libraries that provided the core services into unending programs that control system resources because of the early needs of accounting for computer usage and then protecting those records. A program or application compatible with the OS, executes instructions written in a high-level language and may use kernels to activate the basic services of the OS. There are two ways to run programs written in a high-level language. The most common is to compile the program; the other method is to pass the program through an interpreter. An interpreter translates high-level instructions into an intermediate form, which it then executes. In contrast, a compiler translates high-level instructions directly into machine language. Compiled programs generally run faster than interpreted programs. The advantage of an interpreter, however, is that it does not need to go through the compilation stage during which machine instructions are generated. This process can be time-consuming if the program is long. The interpreter, on the other hand, can immediately execute high-level programs. For this reason, interpreters are sometimes used during the development of a program, when a programmer wants to add small sections at a time and test them quickly. Both interpreters and compilers are available for most high-level languages.

ERP (enterprise resource planning) is an industry term for the broad set of activities supported by multi-module application software that help a manufacturer or other business manage the important parts of its business, including product planning, parts purchasing, maintaining inventories, interacting with suppliers, providing customer service, and tracking orders

API (application programming interface) is an interface that is used by one application program to communicate with programs of other systems. ERP vendors provide APIs for integrating other applications with their ERP systems.

Bolt-On is a software application that performs specific tasks and that interfaces with an ERP system, such as the one offered by Intermec, Inc. “Manufacturing Execution Systems” and “Warehouse Management Systems”.

DLL (dynamic link library) is a library of core elements required by the Windows architecture, a DLL contains all the functions and definitions needed to communicate with a program at run time.

Function Library is a body of ready-made, reusable units of code for specific programming tasks that can be implemented in an ERP program or called by external applications.

Middleware: The software interface or link that enables data to pass from the source to a client, such as the middleware that enables a mobile terminal to interface with ERP applications.

Template Libraries are code libraries used by applications to access pre-defined sets of instructions by reference of headers.

Smart Cards are small devices that resemble a credit card but contain an embedded microprocessor to store and process information. Magnetic-stripe cards, which store a very small amount of information (most typically used to identify the owner) and have no processing capability of their own, can be thought of as primitive smart cards. A true smart card contains 80 or more times as much memory, and the microprocessor allows information to be read and updated every time the card is used. Contact cards, which must be swiped through card readers, are less prone to misalignment and being misread but tend to wear out from the contact; contactless cards, which are read by holding the card in front of a low-powered laser, can be used in mobile applications, such as collecting tolls from cards as drivers pass through toll booths without stopping. Integrated Circuit (IC) Memory Cards can hold up to 1-4 KB of data, but have no processor on the card with which to manipulate that data. Thus, they are dependent on the card reader for their processing and are suitable for uses where the card performs a fixed operation. Memory cards represent the bulk of the 600 million smart cards sold in 2000, primarily for pre-paid, disposable-card applications like pre-paid phone cards. Memory cards are popular as high-security alternatives to magnetic stripe cards. Integrated Circuit (IC) Microprocessor Cards offer greater memory storage and security of data than a traditional magnetic stripe card. Chip cards also can process data on the card. The recent generation of chip cards has an eight-bit processor, 16 KB ROM, and 512 bytes of RAM. These cards are used for a variety of applications, especially those that have cryptography built in, which requires manipulation of large numbers. Java Card belongs to this category.

Short-range wireless communications systems find use in automatic identification systems (AIS). Radio Frequency Identification (RFID) systems are one embodiment of AIS which find use in short-range wireless communication system. The typical RFID system includes a RFID reader and a RFID transponder linked together by a radio frequency generated by the reader. The transponder is attached or coupled to an item for identification purposes. RFID readers are typically connected to or integrated into microprocessor driven devices or computers, running software applications under a specific OS. RFID systems are described in the text “RFID Handbook-Radio-Frequency Identification Fundamentals and Applications” by K. Finkenzeller, published by John Wiley & Sons LTD, New York, N.Y. (ISBN 0-471-988510) 1999, pages 6-7, and fully incorporated herein by reference.

The reader may be incorporated into a fixed or a mobile device which communicates with the RFID transponder via a radio frequency signal. The reader sends out a RF signal that “wakes up” the RFID transponder. The transponder may be active or passive. In response to the RF signal, the transponder transmits a data signal back to the reader via a RF frequency signal. The transponder or “tag” includes a memory and is incorporated into an item. The tag stores data descriptive of the item for identification purposes. The memory may be random access or read only or erasable read only memory and the like. Data is stored in the memory in a customized data structure and format, according to the requirements of an application executable in the mobile devices or in an external network.

RFID tags are manufactured with a unique identification number (ID) or can have such ID stored in a specific memory location, usually ROM using a process called masking.

The Electronic Product Code, (EPC), is an ID used in RFID tags that is intended as an improvement on the UPC barcode system. The EPC is a 96-bit tag which contains a number called the Global Trade Identification Number (GTIN). Unlike a UPC number, which only provides information specific to a group of products, the GTIN gives each product its own specific identifying number, giving greater accuracy in tracking. The EPC was the creation of the MIT AutoID Center, a consortium of over 120 global corporations and university labs. The EPC system is currently managed by EPCGlobal Inc., a subsidiary of the Electronic Article Numbering International group and the Uniform Code Council (UCC), creators of the UPC barcode. EPC's vision is sometimes referred to as the “Internet of Things”. EPC would leverage the benefits of RFID's non-line-of-sight reading, large data capacity and anti-theft/anti-counterfeiting features. This combined with the ability to retrieve information over the internet about the product (who manufactured it and when, where it has been, when is its expiration or warranty date, etc) is enabling a powerful and flexible supply chain.

Auto-ID Reader Protocol 1.0 defines Version 1.0 of the wire protocol by which tag readers interact with Auto-ID compliant software applications. The Reader Protocol specifies the interaction between a device capable of reading (and possibly writing) tags, and application software.

Auto-ID Savant Specification 1.0 defines a Savant as software that sits between tag readers and enterprise applications, providing a variety of computational functions on behalf of applications.

The art is limited since all RFID reader devices compatible with EPC must be programmed in advance to recognize a specific format mandated by the standard, so older RFID reader devices must be reprogrammed and when new standards or formats appear it shall be also necessary to reprogram the devices.

CPU enabled RFID tags, such as those incorporating Inside Contactless' Micropass chip, allow that applications are run in the RFID tag by means of a tag OS. There are companies such Inseal, Inc. (Jaycos) and Sun Microsystems (Javacard) which offer OSs for cards that control the way applications run when read by a reader to provide strong security requirements for RFID applications. Reader devices running RFID applications can be programmed to read the tag applications and interact with them. The art is limited because the RFID application in the reader device must already be programmed in order to run and interact with the tag application. In addition, the current art is limited because the OS does not offer a solution on how to control I/Os and other sensors connected to the RFID reader devices.

Sun Microsystems' Javacard allows that RFID applications are stored in RFID cards and loaded into the RFID reader device to control the display of text and to prompt an user for input. This art is limited because it requires a Java Virtual Machine program to be running in the RFID reader device, and only devices with OS compatible with this program can use it. In addition, this art is limited because this program is generic and cannot be programmed to interact with I/Os such as sensors connected to the reader device. In addition, this solution does not allow parsing applications over more than one tag and does not provide a control file that allows selective execution of applications contained in the tags. In addition, this solution requires specific knowledge of the Java programming language in order to program the applications.

RFID reader devices may incorporate sensors of location (such as global positioning technology (GPS) devices), temperature, pressure, chemicals, radiation, etc. The data deriving from this sensors is used in combination with software applications running in the RFID devices to allow users to make decisions or allow systems to record relevant information related to the item to which the RFID tag is pegged. The art is limited in that the software applications running in the RFID devices must be preprogrammed, so for each new item type requiring a different decision type or recording of information the devices must be reprogrammed.

Electronic controllers are used to control the operation of a variety of industrial, commercial and consumer devices. The operation of these controllers is handled by a control software which changes depending on the specific use or destination of the device and which is updated from time to time to correct bugs or improve performance. Generally, to perform changes or updates in the control software it is required to have physical access to electronic interfaces created for this purpose.

What is needed in the art is:

A method or an apparatus used for RFID systems in a fixed or mobile environment for creating and loading into the reader devices new applications with minimum effort by using a reduced instruction or command set which facilitates reading the instruction or command set by devices and executing the instruction or command set to provide customized “ad-hoc” processing depending on the tag read.

A method that uses the same tags used for identifying items as storage means of software applications used for managing the way the items are handled and stored and/or used to provide a service related to the items.

A method to use the reader to load applications from the tag for execution by the reader device thus avoiding the need to have the applications preprogrammed or preloaded into the device.

A method that uses an interpreter or a compiler adapted to the OS of RFID devices to facilitate execution of applications loaded from tags without need of specific compatibility with the device's OS.

A convenient, low cost method that for each tag read, allows the device to execute a RFID application specific to the item identified by the tag.

A method to update applications running in off-line devices conveniently and at a low cost.

A method that conveniently deals with changes and updates to the sets of APIs, Bolt-Ons, DLLs, Function Libraries, Middleware functions and Template Libraries used by the RFID applications to execute complex sets of instructions required to complete a process integrating the RFID system with an ERP.

An apparatus that operates without any preprogrammed or preloaded application and only executes applications read from tags.

An apparatus that is integrated into the electronics of a device that includes the interpreter for use by the device.

A method that allows easy and convenient update of the software programs used in RFID reader devices compatible with EPC for recognizing the EPC format mandated by the standard, when new standards or formats appear.

A method that allows tag applications to automatically interact I/Os and other sensors connected to the RFID reader devices.

A method that allows applications stored in tags to load and run in reader devices without need of a Java Virtual Machine program to be running in the RFID reader device.

A method that allows parsing of Javacard applets so that they can be easily stored in several tags and later retrieved for execution.

A method that allows performing changes or updates in the control software used in electronic controllers without requiring physical access to electronic interfaces created for this purpose.

### SUMMARY OF THE INVENTION

A first software program running on a PC is used to create and optimize applications destined to run in fixed or mobile devices incorporating RFID readers. The applications are created using a custom command set. The first program optimizes the application to fit in the memory of one or more RFID memory tags. The first program stores the applications in one or more RFID tags in memory locations whose starting and ending addresses are recorded in a control file. The first program also stores in a predetermined location in the memory of the RFID tags the control file specifying the location, contents and other control information regarding the applications. To read and run the applications, the devices are loaded with a second program adapted for interfacing with the OS of the device and which runs alongside the normal RFID application running in the device. The second program runs when the reader function of the device is activated and automatically checks the predetermined location of the tag. If the file is not found, the second program transfers control of the device to the normal RFID application. If the control file is found, the second program reads the information contained in the file and executes the application or applications as indicated by the control file. When the applications finish running, the second program transfers the control of the device to the normal RFID application.

An aspect of the invention is running the first program from a custom chip embedded in a PC card or in a device attached to a PC, and have the program accessed from the PC.

Another aspect of the invention is to have the first program operate as a compiler or having it replaced by a compiler of a high level language that creates the application as an executable file compatible with the OS of the RFID reader device, and have the second program to cause the execution of the executable file as is.

Another aspect is to have the first program accessed and operated remotely via internet.

Another aspect is the first program always using the same specific block of memory to store the control file and the second program always looking for the control file in the same specific block of memory.

Another aspect is the first program encrypting the applications so that they can be run only when a second program holds the correct decryption key.

Another aspect is the first program capable of parsing an application over multiple tags to overcome the constraint of limited memory of tags.

Another aspect of the first program is that it stores in the tags additional data files for use by the applications, it includes the location and control information relative to this data files in the control file, it interacts with and programs the OS of cpu-enabled tags to set conditional access to this data and it programs the application for use of the conditional access.

Another aspect of the first program is that it can use Java or Javacard Java applets as applications to be stored in the tags and parse them over several tags if necessary.

Another aspect is the control file including commands that direct the second program how to read the applications when they are parsed over several tags.

Another aspect is the control file including commands that direct the second program on whether to interpret the applications commands into commands recognized by the OS of the RFID reader devices, or cause to execute it as an executable file.

Another aspect is the control file including commands that direct the second program in which order to execute the applications.

Another aspect is the control file including commands that direct the second program how to condition or restrict access to the applications.

Another aspect is the control file including information on the location and access restrictions of additional data stored in the tags that may be required by the applications depending on the reader device that runs them.

Another aspect of the control file is that includes security features that combine with security features of the second program to authenticate the origin of the applications, as a means to avoid that software viruses are loaded into the devices.

Another aspect of the control file is that it may be located using predefined identifiers instead of using a predetermined location.

Another aspect of the first program is that it stores in each tag where one or more applications are stored or parsed, a control file that contains control information about the whole set of tags, so that the second program can run the applications in the proper order notwithstanding the order in which the tags are read.

Another aspect is the second program accessing the device's OS to control external devices connected to the RFID reader device, such as sensors, and create a set of commands understood by the second program such that each command in the set is mapped to a corresponding command used by the OS to operate the external device and the set is used by the first program when creating the applications so that when the applications are loaded and run they can interact with the sensor devices.

Another aspect of the second program is that it creates an internal memory stack in the device's memory where it stores all the applications read from the tags, and it validates the applications before running them.

Another aspect of the second program is that it enables the applications to interact with the OS of the tag in order to control the tag applications for tags with CPUs.

Another aspect of the second program is accessing the control file by interaction with the tag OS.

Another aspect of the second program is causing the execution of a tag application commanded by the OS of the tag.

Another aspect of the applications created is that they may be configured as a processing module of a Savant, as defined in “Auto-ID Savant Specification 1.0”

Another aspect of the applications created is that they may be configured to run independently from Savants, as defined in “Auto-ID Savant Specification 1.0”

Another aspect of the applications created is that they may be configured to remotely invoke APIs, Bolt-Ons, DLLs, Function Libraries, Middleware functions and Template Libraries using an index accessed via internet.

Another aspect of the second program is that it can be adapted to interact with a Java Virtual Machine so that the second program uses the control file to direct precedence of execution of Javacard applets read from the tags and to regroup parsed Javacard applets so that they can be executed by the Java Virtual Machine.

Another aspect of the invention is that it is tag type (active/passive) independent, tag RF frequency independent and RFID protocol independent and correspondingly independent of type, frequency and protocol used in RFID readers.

Another aspect of the invention is that it can be implemented in devices incorporating an RFID reader which do not have a specific RFID application running, but only the second program.

Another aspect of the invention is that applications can be programmed to run only in pre-authorized devices by doing authentication checks such as mac address verification, reader ID verification or other unique identifiers of the devices.

Another aspect of the invention is that the second program can use an application read from the tag to control the RFID reader to correctly read from the tag an otherwise unrecognizable ID format, for example a new EPC standard.

Another aspect of the invention is that the first program compresses, encrypts and stores in tags, data files containing data required for EDI documents, using a unique identifier stored at the beginning of the file to identify the type of document and EDI standard used, and writes corresponding information in the control file stored in the tag.

Another aspect of the invention is that an application stored in the tag interacts with the second program to provide selective access and read files containing data required for EDI documents, using the unique identifier to create a standard EDI document.

Another aspect of the invention is that the second program is stored and run in electronic controllers used for controlling equipment or devices, and which are equipped with RFID readers, so that a tag application can be used to modify the controlling software.

Another aspect of the invention is that the application loaded and run by the second program becomes itself a second program that retrieves and executes the application from another remote source, such as an URL.

Another aspect of the invention are tags which at the time of manufacturing or at a later stage prior to the use of the first software program, are masked or programmed with a control file and/or one or more applications for use in conjunction with a second software program, or a similar program running in RFID reader devices, for the execution of the application read from the tag.

Another aspect of the invention and of the subsequent aspects indicated above is the use of smart cards instead of RFID tags to store the applications, and use smart card reader devices instead of RFID reader devices.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DESCRIPTION OF DRAWINGS

FIG. 1 is a representation of the setting required to operate an RFID application generator and writer system in the preferred embodiment, incorporating a PC with access to a remote index of applications via a network (internet, intranet, etc.), and equipped with a RFID reader/writer device used to store an RFID application in one or more RFID tags. This FIG. 1 describes the preferred embodiment of the setting required to create RFID applications that are stored in RFID tags, which is required to operate the method incorporating the principles of the present invention.

FIG. 2 is a representation of the method used in the RFID application generator and writer system incorporating the principles of the present invention and which operates in the setting described in FIG. 1.

FIG. 3 is a representation of a typical RFID reader device implied in the preferred embodiment, incorporating a CPU, memory, display, input output means and connectors, a communications module with access to a remote index of applications via a network (internet, intranet, etc.), and equipped with a RFID reader/writer device used to read the RFID application stored in one or more RFID tags. This FIG. 3 describes the preferred embodiment of the setting required to read and run RFID applications that are stored in RFID tags, which is required to operate the method incorporating the principles of the present invention.

FIG. 4 is a representation of the method used in the RFID reader device for reading an running applications, incorporating the principles of the present invention and which operates in the setting described in FIG. 3.

FIG. 5 is a representation of the method used in the RFID reader device for interpreting and executing the commands integrating the applications that are stored in RFID tags, which is a subset of the representation described in FIG. 4, incorporating the principles of the present invention and which operates in the setting described in FIG. 3.

### DETAILED DESCRIPTION OF THE INVENTION

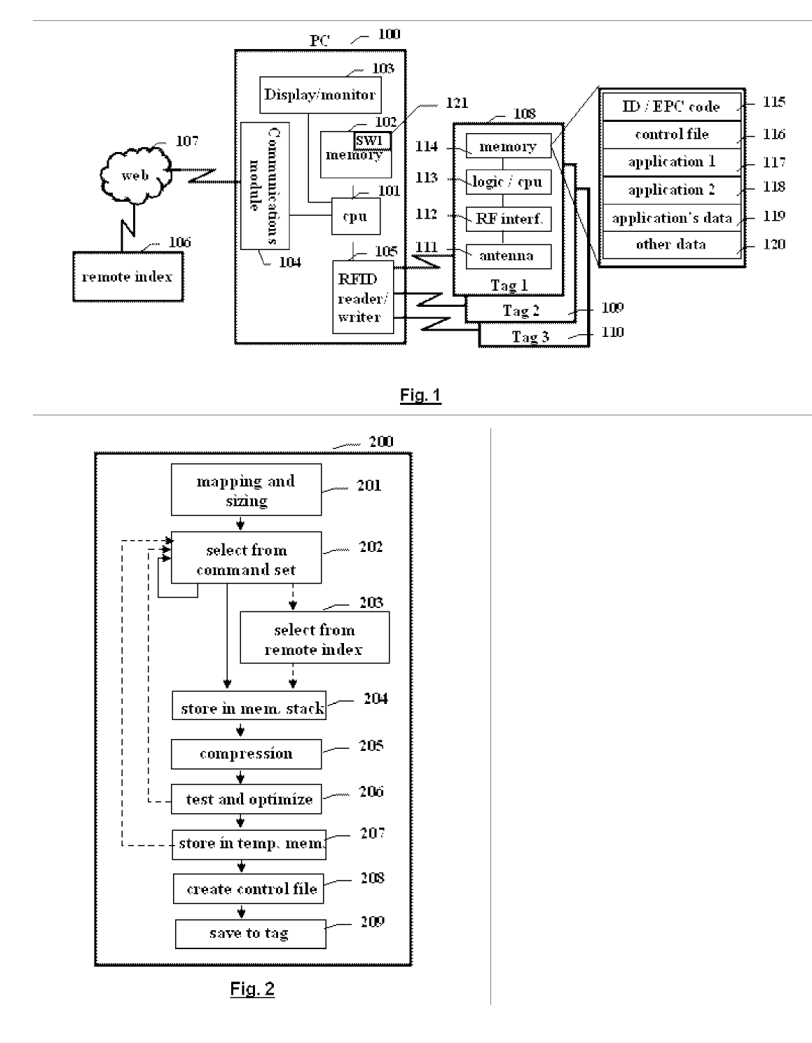

FIG. 1 discloses the setting required to operate an RFID application generator and writer system in the preferred embodiment, incorporating a personal computer (PC) 100 comprising a central processing unit (CPU) 101, a memory module 102, a monitor 103, a communications module 104, and a RFID reader-writer 105. A keyboard (not shown) enables a user to input instructions and/or data to the processor. An operating system (not shown) residing in the memory module 102, typically a Microsoft Windows Version controls the operation of the PC. A software application for the creation of RFID applications and which incorporates principles of the present invention (SW1) 121 is stored in the memory module 102 and run by the CPU 101. The PC 100 is linked to a remote index 106 via an external network which can be the internet 107 or an Intranet, a mobile phone network, a PSTN, a PBX or the like (not shown). The RFID reader-writer 105 contains a radio frequency interface consisting of a receiver and transmitter with an antenna (all not shown). The interface may have two separate data paths for reading and writing from/to passive RFID transponders or tags 108, 109 and 110. Further details describing the reader are described in the text “RFID Handbook”, supra, Chapter 11.

A passive RFID tag included in the preferred embodiment 108 uses an antenna 111, a RF interface 112 and a logic circuit 113 which may be a CPU, to hold and manage communications with the RFID reader-writer 105. Any type of tag, active or passive, operating in any frequency 114 may be used in the present invention. RFID tags can be either active or passive. Active tags require an internal battery or another type of power source and are often read/write tags. Passive tags do not require a dedicated power source, but rather obtain operating power generated from RF signals provided by a reader. Tags may come in a variety of shapes and sizes, but are generally based on a custom-designed silicon integrated circuit. Any transponder/tag with memory may be used in connection with the present invention, and the tag type, size, etc., depends on the particular environment and identification purpose.

Before further describing the invention, a brief description of RFID technology is believed appropriate. RFID technology utilizes electromagnetic or electrostatic coupling in the radio frequency (RF) portion of the electromagnetic spectrum. The reader/writer 105 (hereinafter the “reader”) is miniaturized and includes an interface network layer. Readers are described in the text “RFID Handbook”, supra, at Chapter 11. The reader includes an antenna (not shown) for transmitting a RF signal that activates the transponder or tag 108. When the tag 108 is activated, it transmits information back to the reader 105. In the case of a passive tag, the tag may be energized by a time-varying electromagnetic RF wave generated by the reader. When the RF field passes through the antenna coil associated with the tag, a voltage is generated across the coil. This voltage is ultimately used to power the tag and make possible the tag's return transmission of information to the reader, sometimes referred to as back-scattering. The reader passes the information to the memory stack for delivery to the application in the device or to an application in the external network. A processor is coupled to the memory and to the reader. The processor is configured to invoke at least the application and to provide the content to the local application as directed by the reader application. In the tag 108, a radio frequency interface 112 is linked to an address logic unit or cpu 113 for reading and writing data from/to a memory 114, typically a ROM or EEPROM or the like. The radio frequency unit serves as the interface with the reader 105 and may transmit a signal when within the RF zone of the reader. The interface demodulates the reader signals for processing in the address logic unit 113. The address/logic unit 113 controls all reading and writing processes on the tag via a state machine (not shown). Data is stored in the memory 114 using logical addressable partitions depending on the use and type of tag, and typically the partitions may be defined and modified by a means of a reader software application which controls the address/logic unit 113. The memory can be logically controlled by the address/logic unit 113 to provide conditional access to partitions and specify read only, read/write, write once, etc. features. Typically there's a ROM/EEPROM memory were a unique identifier (ID) 115 is masked by the tag manufacturer. The ID may also be defined by an user in a first partition of a RAM module. Further details on the operation of the tag are described in the text “RFID Handbook”, supra pages 171-177.

Returning to the invention, FIG. 2 discloses the method used in SW1 121 to create and optimize applications 200 destined to run in fixed or mobile devices incorporating RFID readers, incorporating the principles of the present invention and which operates in the setting described in FIG. 1. The method commences by mapping and sizing 201 of the memory of the tag or tags deemed to store the applications, a step that is required to allow flexibility in the type and memory sizes of tags employed. The applications are created using a custom command set, such as write (to memory address/file), read (from memory address/file), display (text), prompt (an user to enter data), open port (an i/o port in a device), execute (code such as an API, Bolt-On, etc. referred to via a unique identifier as described below), etc. The command set is defined by name (command name) and each command is uniquely identified by a number to reduce memory size usage when the application is stored in the tag. Applicable commands are provided with argument definition capabilities. The user selects one or more commands by name from a command set library 202 and orders them as an executable flow which SW1 stores in a memory stack 204. The flow is stored using a structured format which identifies command by number, corresponding arguments, order of execution of the commands and the required iterations and decision trees typical of applications. SW1 provides an interface for the user to include in the application commands that execute pre-defined code such as APIs, Bolt-Ons, DLLs, Function Libraries, Middleware functions and Template Libraries each code referred to by a unique identifier, by selecting the unique identifier 203 from a remote index 106 accessed via internet 107. The remote index 106 is a listing by name of standard, publicly known code used by commercial ERP and data base systems, each code identified by a unique identifier. The remote index should be periodically updated so it is sensible to propose such a centralized index administered by a capable administrator in charge of continuously updating the index. After selection of commands 202 and additional code from remote index 203, the flow for execution is completed an stored in the memory stack 204. The method of SW1 then proceeds to apply a known data lossless compression algorithm 205 which may be chosen from publicly available sources such as those described in http://datacompression.info/, with the only constraint that the decompression algorithm can be implemented in all reader devices destined for running the application. The method then proceeds with a process of testing and optimizing 206 consisting in decompressing back and executing the application (the integrated flow of commands stored in the memory stack) and reviewing the flow for consistency and completeness from the point of view of the user's requirements, followed by a comparison test that checks that the resulting application size does not exceed the memory available in the tag memory deemed for storing the application 117, after reserving a specific memory block to contain the control file 116 and reserving a memory block for additional data 119 and 120 that may be required to operate the application and about which the user is prompted. In the case that it exceeds the allocated memory space, the user chooses between parsing the storage of the application among several tags or re-doing the process of creating the application choosing less commands. Once optimized, the application is saved in a temporary memory 207. The process then creates a control file 208 which contains in a structured form information regarding number of tags used, number assigned to current tag (to distinguish the tags from each other), number of applications saved, location of each application, indication of parsed applications with reference to tag number and starting and ending memory blocks, control information regarding unique identifiers of authorized readers to run each applications, access controls to each applications, tag number and memory location of data required by each application, and any other relevant information required to access and run the applications. One control file is created for each tag containing parsed or grouped applications, with the difference between control files being that a different tag number is stored in each control file to be able to distinguish them from one another. The control file 208 is then stored in a predefined location in the tag 116 and the corresponding application is saved in the memory block assigned 117 (118 and 119 if more applications are stored). In addition, if application data has been entered by the user, it is then stored in the memory block assigned for this purpose 120. This operation is repeated for each additional tag 109, 110 required by the number of applications or parsed applications. The use of memory blocks in each tag may be conveniently assigned differently, where applications are grouped in one or more tags and application data in other tag or tags.

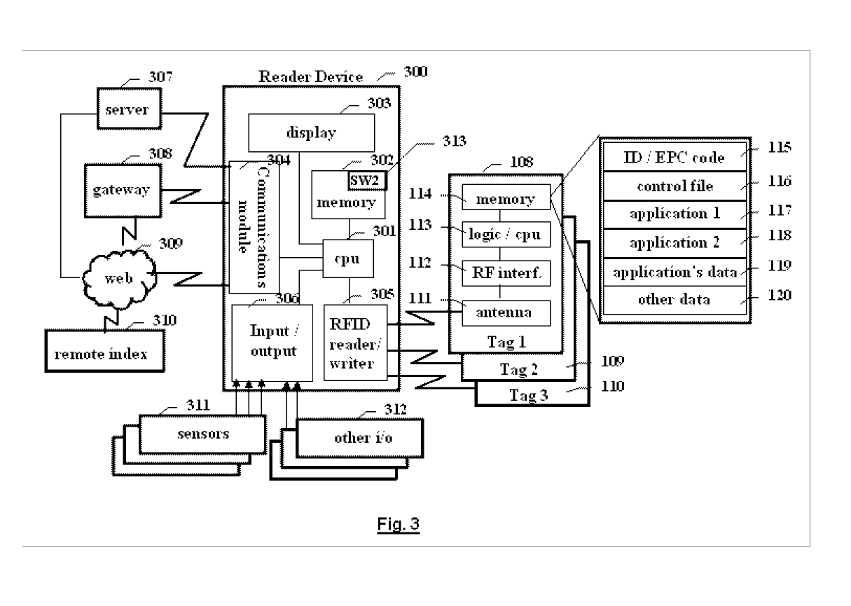

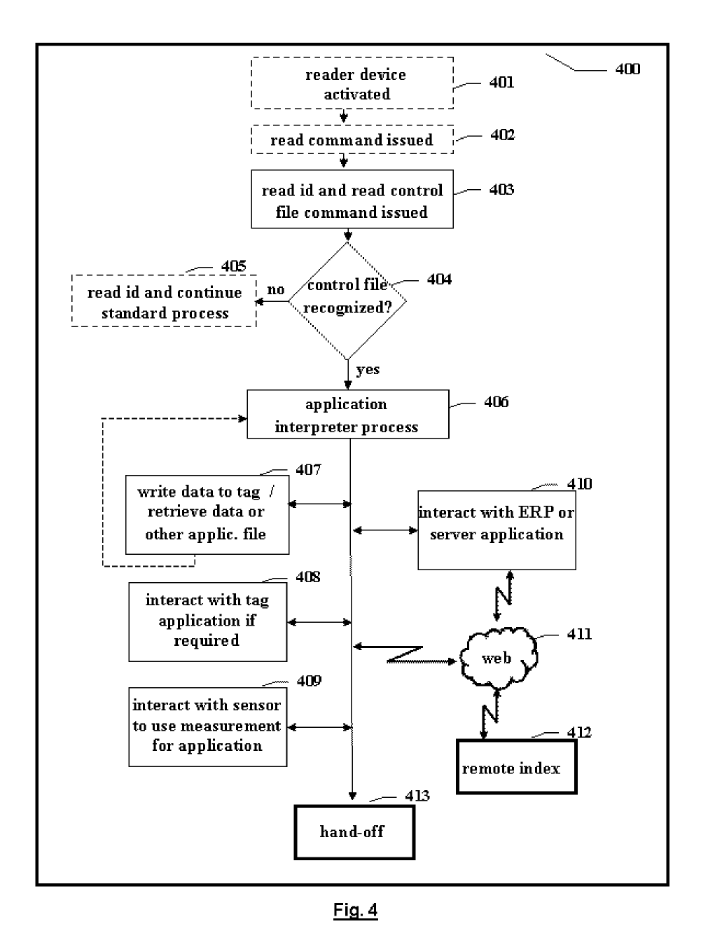

FIG. 3 discloses the setting of a typical RFID reader device 300 implied in the preferred embodiment, incorporating a central processing unit (CPU) 301, a memory module 302, a display 303, a communications module 304, a RFID reader-writer 305, and input/output means such as a keyboard (not shown) and input/output electronic connectors (I/O) 306 controlled by the CPU 301. An operating system (OS) (not shown) residing in the memory module 302, controls the operation of the RFID reader device 300. A software application for reading, interpreting and executing applications stored in tags and which incorporates principles of the present invention (SW2) 313 is stored in the memory module 302 and run by the CPU 301. Another software application (normal RFID application) used for “normal” handling of RFID data (not shown) is also stored in the memory module 302 and run by the CPU 301 automatically or upon command by a user. The RFID reader device 300 is linked to a remote index 310 via an enterprise server 307, a mobile gateway 308, or an external network which can be the internet 309. The I/Os 306 provide the RFID reader device 300 with connection to sensors 311 such as sensors of location (such as global positioning technology (GPS) devices), temperature, pressure, chemicals, radiation, etc. The RFID reader-writer 305 operates in a similar fashion to the one described previously regarding FIG. 1.

SW2 313 is adapted to work under the OS controlling the operation of the RFID reader device 300. The method to do the said adaptation consists of mapping, for each command included in the command set used by SW1 112, a corresponding command recognized by the OS, and creating a correspondence index (not shown) that can be used to interpret the command used by SW1 112 to create the application into the command recognized by the OS. In addition, SW2 is adapted to interact with the OS in a fashion such that when a “read tag” command is issued to the OS by the normal RFID application, the execution of the normal RFID application is interrupted and command is handed to SW2.

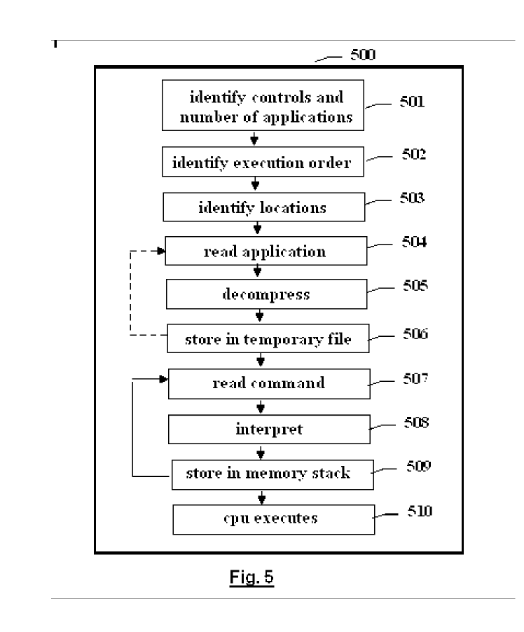

FIG. 4 discloses the method used in the RFID reader device for reading an running applications. The RFID reader device 300 is activated 401 and a read command is issued 402 by the normal RFID application. The execution of the normal RFID application is interrupted and a command is given to read the tag's ID, as it would be read by the normal RFID application, and in addition, a command is given to the RFID reader to read 403 the control file 116 from the tag 108. The method then verifies if the control file is valid 104. In the event it is not valid, the program hands over control to the normal RFID application 405. In the event the control file is a valid one, the method proceeds with the application interpreter process 406 and 500 described in FIG. 5. The program uses the control file to identify the application controls that may restrict the use of the application and performs the controls if required, and proceeds to identify the number of applications stored in the tag or tags 501, identify the execution order 502, identify the tag number and memory locations where the applications and related data are stored 503, and based on the information gathered proceeds to read the allowed application 504, decompress it 505 by reversing the algorithm used for compression by SW1 112, and storing the decompressed file in a temporary file 506. If more than one application is allowed or required for execution (as per the controls defined by SW1 in the control file), the process of reading 504, decompressing 505 and storing 506 is repeated. The method then proceeds to read 507 and interpret 508 the commands into OS recognizable commands using the library mapped when adapting the software to the OS, and stores the command in a memory stack 509. The interpretation process is repeated until all commands have been interpreted and stored in the memory stack. The program then issues the OS an execute command of the application 510. Back in FIG. 4, the loaded RFID application runs and may issue commands to write data to tag or retrieve data or other application file 407 assisted with data provided by the control file, may interact with a tag application (application embedded in a tag with cpu) 408, or interact 409 with data read via I/Os 306 originated by sensors 311 or other I/O devices 312. In addition, the application may interact with enterprise applications 410 either directly (store or retrieve commands) or by invoking code from the remote index 412, accessed via Internet 411 either directly from the RFID reader device 300 or via the enterprise application 410.

The invention has been described in terms of particular embodiments. Other embodiments are within the scope of the invention, including the following:

An aspect of the invention is running SW1 from a custom chip embedded in a PC card or in a device attached to a PC, and have the program SW1 accessed from the PC.

Another aspect of the invention is to have SW1 operate as a compiler or having it replaced by a compiler of a high level language that creates the application as an executable file compatible with the OS of the RFID reader device, and have SW2 to cause the execution of the executable file as is.

Another aspect is to have SW1 accessed and operated remotely via internet.

Another aspect is SW1 always using the same specific block of memory to store the control file and SW2 always looking for the control file in the same specific block of memory.

Another aspect of SW1 is that it tests and optimizes the application before storing it in the tag, and checks the application's size to have it fit the available memory in the tag.

Another aspect is SW1 encrypting the applications so that they can be run only when the correct decryption key is entered into SW2.

Another aspect is SW1 parsing one or more applications over multiple tags to overcome the constraint of limited memory of tags.

Another aspect of SW1 is that it stores in the tags additional data files for use by the applications, it includes the location and control information relative to this data files in the control file, it interacts with and programs the OS of cpu-enabled tags to set conditional access to this data and it programs the application for use of the conditional access.

Another aspect of SW1 is that it can use Java or Javacard Java applets as applications to be stored in the tags and parse them over several tags if necessary.

Another aspect is the control file including commands that direct SW2 how to read the applications when they are parsed over several tags.

Another aspect is the control file including commands that direct SW2 on whether to interpret the applications commands into commands recognized by the OS of the RFID reader devices, or cause to execute it as an executable file.

Another aspect is the control file including commands that direct SW2 in which order to execute the applications.

Another aspect is the control file including commands that direct SW2 how to condition or restrict access to the applications.

Another aspect is the control file including information on the location and access restrictions of additional data stored in the tags that may be required by the applications depending on the reader device that runs them.

Another aspect of the control file is that includes security features that combine with security features of SW2 to authenticate the origin of the applications, as a means to avoid that software viruses are loaded into the devices.

Another aspect of the control file is that it may be located using predefined identifiers instead of using a predetermined location.

Another aspect of SW1 is that it stores in each tag where one or more applications are stored or parsed, a control file that contains control information about the whole set of tags, so that SW2 can run the applications in the proper order notwithstanding the order in which the tags are read.

Another aspect is SW2 accessing the device's OS to control external devices connected to the RFID reader device, such as sensors, and create a set of commands understood by SW2 such that each command in the set is mapped to a corresponding command used by the OS to operate the external device and the set is used by SW1 when creating the applications, so that when the applications are loaded and run they can interact with the sensor devices.

Another aspect of SW2 is that it creates an internal memory stack in the device's memory where it stores all the applications read from the tags, and it validates the applications before running them.

Another aspect of SW2 is that it enables the applications to interact with the OS of the tag in order to control the tag applications for tags with CPUs.

Another aspect of SW2 is accessing the control file by interaction with the tag OS.

Another aspect of SW2 is causing the execution of a tag application commanded by the OS of the tag.

Another aspect of the applications created is that they may be configured as a processing module of a Savant, as defined in “Auto-ID Savant Specification 1.0”

Another aspect of the applications created is that they may be configured to run independently from Savants, as defined in “Auto-ID Savant Specification 1.0”

Another aspect of the applications created is that they may be configured to remotely invoke APIs, Bolt-Ons, DLLs, Function Libraries, Middleware functions and Template Libraries using an index accessed via internet.

Another aspect of SW2 is that it can be adapted to interact with a Java Virtual Machine so that the SW2 uses the control file to direct precedence of execution of Javacard applets read from the tags and to regroup parsed Javacard applets so that they can be executed by the Java Virtual Machine.

Another aspect of the invention is that it is tag type (active/passive) independent, tag RF frequency independent and RFID protocol independent and correspondingly independent of type, frequency and protocol used in RFID readers.

Another aspect of the invention is that it can be implemented in devices incorporating a RFID reader which do not have a specific RFID application running, only SW2.

Another aspect of the invention is that applications can be programmed to run only in pre-authorized devices by doing authentication checks such as mac address verification, reader ID verification or other unique identifiers of the devices.

Another aspect of the invention is that SW2 can use an application read from the tag to control the RFID reader to correctly read from the tag an otherwise unrecognizable ID format, for example a new EPC standard.

Another aspect of the invention is that SW1 compresses, encrypts and stores in tags, data files containing data required for EDI documents, using a unique set of identifiers stored at the beginning of the file or in a control file to identify the type of document and EDI standard used, and writes corresponding information in the control file stored in the tag, so that SW2 can produce the corresponding EDI document.

Another aspect of the invention is that SW2 is stored and runs in electronic controllers used for controlling equipment or devices, and which are equipped with RFID readers, so that a tag application can be used to modify the controlling software.

Another aspect of the invention is that the application loaded and run by SW2 itself becomes a kind of SW2 that retrieves and executes the application from another remote source, such as an URL.

Another aspect of the invention are tags which at the time of manufacturing or at a later stage prior to the use of SW1, are masked or programmed with a control file and/or one or more applications for use in conjunction with SW2, or a similar program running in RFID reader devices, for the execution of the application read from the tag.

Another aspect of the invention and of the subsequent aspects indicated above is the use of smart cards instead of RFID tags to store the applications, and use smart card reader devices instead of RFID reader devices.

The invention contemplates that there exist other embodiments of SW1 regarding mapping and assignment of tag memory areas for storage, creation of command sets, selection of commands, selection from remote index, compression, test and optimization, configuration or format of the control file and storage allocation for the control file all which are within the scope of the present invention. The invention also contemplates that there exist other embodiments of the control file that may include additional data, a different format or a different positioning strategy, all which are within the scope of the present invention. In addition the invention contemplates that there exist other embodiments of SW2 regarding the process indicated in FIG. 4 and FIG. 5, all which are within the scope of the present invention.

What is claimed is:

1. A method implemented in a local or remotely accessed computer system comprising creation of software applications by:
defining a maximum size allowed for the software application;
using for the software application a limited set of commands that may be identified with a unique identifier or symbol and that may be selecetd from a local or remote command library;
compressing and/or encrypting the application using a known data lossless compression method;
comparing the size of the application with the maximum size allowed;
notifying if the size of the application meets or exceeds the maximum size allowed.

2. A method implemented by means of a RFID system comprising:
one or more transponders each with memory size equal to the maximum size allowed for the software application of claim 1;
an RFID reader/writer device;
and a computing or controlling device that controls the reader/writer device;
the method comprising:
creating for each transponder a control file containing in structured form information comprised of:
number of total blocks used to contain the software application of the method of claim 1;
ordinary number assigned to the transponder used to contain the software application of claim 1;
number of software applications of the method of claim 1 stored in the transponder;
in sequential order, beginning memory address of the location of each software application of claim 1 stored in the transponder;
number indicating the presence of a parsed software application of claim 1;
registry containing identifiers of authorized readers and beginning memory address of software applications allowed to be read by each authorized reader;
registry containing cryptographic keys required to activate applications;
registry indicating that a stored application is in executable form;
registry indicating the location and control information relative to data files for use by the applications or by the control file;
transponder number and beginning memory address of data required by each application;
the method further comprising:
storing the control file in a predetermined location of each transponder, such predetermined location depending on the memory architecture implemented by the manufacturer of the transponder;
storing the software applications of claim 1 in one or more transponders according to the location information contained in the control file.

3. A fixed or mobile device such as a data collection station, data collection terminal, access gate, cellular phone, point of sale terminal or other electronic devices comprising:
a central processing unit;
a memory module;
a display;
a wireless or wired communications module or device;
a RFID reader-writer either integrated or connected externally via cable;
input/output means such as a keyboard;
input/output electronic connectors (I/O) controlled by the central processing unit;
an operating system (OS) and other software applications residing in a memory module providing control over the operation of the device and the RFID reader-writer.

4. A method implemented by means of a software or a custom chip or apparatus in the device of claim 3 for reading and executing the software applications of claim 1 comprising:
interrupting the software application controlling the RFID reader-writer of claim 3 when such software application is activated;
recognizing the control file of claim 2;
returning the control over the software application controlling the RFID reader-writer of claim 3 if the control file is not found;
reading the control file;
executing a method that uses the control file to identify the location of the application or applications stored in the transponder of claim 2, identify the application authorized for use by the device of claim 3 and authorize the device to access and read the application;
reading the application;
decompressing and/or decrypting the application;
using an interpreter incorporating the limited set of commands of claim 1 each such command mapped to a corresponding command recognized by the OS, to translate the commands of claim 1 into commands recognized by the OS;
causing the execution of the translated application;
returning control to the OS of the device.

5. The method of claim 1 being a software compiler of a high level language that creates the application as an executable file compatible with the OS of the target device.

6. The method of claim 1 using Java or Java card Java applets as applications.

7. The control file of claim 2 including security information used by the method of claim 4 to authenticate the origin of the applications, as a means to avoid that software viruses are loaded into the devices.

8. The control file of claim 2 containing control information about the whole set of transponders, so that the method of claim 4 can run the applications in the proper order notwithstanding the order in which the transponders are read.

9. The method of claim 1 using commands deemed for control of external devices connected to the device of claim 3, such as sensor devices.

10. The method of claim 4 causing the applications to interact with the OS of the transponder in order to control the transponder applications for transponders with CPUs.

11. The method of claim 4 accessing the control file by interaction with the transponder's OS for transponders with CPUs.

12. The method of claim 4 causing the execution of a transponder application commanded by the OS of the transponder.

13. The method of claim 1 configuring the application as a processing module of a Savant, as defined in “Auto-ID Savant Specification 1.0”.

14. The method of claim 1 configuring the application to remotely invoke APIs, Bolt-Ons, DLLs, Function Libraries, Middleware functions and Template Libraries using an index accessed via internet by the device of claim 3.

15. The method of claim 4 interacting with a Java Virtual Machine using the control file to direct precedence of execution of Java card applets read from the transponders and to regroup parsed Java card applets so that they can be executed by the Java Virtual Machine.

16. The method of claim 1 wherein the application is programmed to run only in pre-authorized devices by doing authentication checks such as Mac address verification, reader ID verification or other unique identifiers of the devices.

17. The device of claim 3 being an electronic controller used for controlling equipment or devices, equipped with RFID readers, so that a transponder application can be used to modify the controlling software.

18. The method of claim 1 wherein the application includes commands directing the device of claim 3 to authorize its access to a remote source such as an URL, command the retrieval of a specific application from the remote source and cause its execution.

19. The method of claim 4 causing the RFID reader/writer of the device of claim 3 to:
store in a memory location of the transponder any type of data required for tracing or reporting an event;
delete or modify data stored in a memory location of the transponder.

20. The system of claim 2 comprising a smart card, a smart card reader/writer and a computing or controlling device, and correspondingly, the device of claim 3 comprising a smart card reader instead or in addition to the RFID reader.
